(19) United States
(12) Patent Application Publication
(10) Pub. No.: US 2014/0307233 A1
(43) Pub. Date: Oct. 16, 2014

(54) PROJECTION APPARATUS

(71) Applicants: Yen-Po Chang, Hsinchu (TW); Hui-Ping Chen, Hsinchu (TW)

(72) Inventors: Yen-Po Chang, Hsinchu (TW); Hui-Ping Chen, Hsinchu (TW)

(73) Assignee: YOUNG OPTICS INC., Hsinchu (TW)

(21) Appl. No.: 14/105,109

(22) Filed: Dec. 12, 2013

(30) Foreign Application Priority Data
Apr. 10, 2013 (CN) 201310122683.3

(51) Int. Cl. G03B 21/28

(52) U.S. Cl. CPC G03B 21/28
USPC 353/98

(57) ABSTRACT

A projection apparatus includes a casing with an opening, a light-emitting unit in the casing and emitting a first projection beam, and a reflective component in the casing and on a transmission path of the first projection beam. The first projection beam reflected by the reflective component becomes a second projection beam projected out via the opening along a projection direction. The light-emitting unit includes a projection lens with an optical axis between a center of the reflective component and the opening of the casing.

### CROSS-REFERENCE TO RELATED APPLICATION

This application claims the priority benefit of China application serial no. 201310122683.3, filed on April 10, 2013. The entirety of the above-mentioned patent application is hereby incorporated by reference herein and made a part of this specification.

### BACKGROUND OF THE INVENTION

1. Field of the Invention

The invention generally relates to an optical device, and more particularly, to a projection apparatus.

2. Description of Related Art

Recently, the development of the miniature projection technologies began to attract the attention of many people, and thus the pico projector (mini projector) has gradually played a main role on the personal digital product market. Various electronic products are developing toward the trend of high-speed, high-performance and light-thin-short-small figure. A pico projector has the advantage of portability and usage without application-site constraints, and it can be integrated into a handheld electronic device such as mobile phone or digital camera.

In general, the projection beam of a pico projector requires and has an offset relative to the optical axis of the projection lens so that the projection beam can be wholly projected onto a projection surface instead of onto a desktop to avoid affecting the integrity of the projected images. In a known pico projector 50 of FIG. 1, a first projection beam L1 is transmitted towards a reflective component 54 from a projection lens 52. After being reflected by the reflective component 54, the first projection beam L1 becomes a second projection beam L2 to be projected to the external environment along a projection direction D1 via an opening 56a of a casing 56. As shown in FIG. 1, the first projection beam L1 has an offset on an offset direction D2 relative to the optical axis A of the projection lens 52, which enables the second projection beam L2 to be projected out in upper-deflected way. However, the offset direction D2 of the first projection beam L1 is designed as the same as the projection direction D1 of the second projection beam L2, and the center 54a of the reflective component 54 is located between the optical axis A of the projection lens 52 and the opening 56a of the casing 56, such that the light L12 of the first projection beam L1 deflected from the optical axis A travels a longer path to arrive at the reflective component 54. As a result, the reflective component 54 accordingly has a larger length d along the projection direction D1, and the casing 56 for accommodating the reflective component 54 has a larger thickness T (for example, greater than 15 mm) along the projection direction D1, which becomes a disadvantage for developing the pico projector and the handheld electronic device towards the lighter and thinner figure.

U.S. Pat. No. 6,929,370 discloses a projector, in which a projection mirror is configured for reflecting a projection beam from a lens to project the image onto a projection surface. U.S. Pat. No. 7,128,425 discloses a projector, in which its reflection mirror is configured for reflecting the projection beam and able to swing freely so to change the direction of the projection beam.

### SUMMARY OF THE INVENTION

Accordingly, the invention is directed to a projection apparatus with a smaller thickness.

Other objectives and advantages of the invention should be further indicated by the disclosures of the invention.

To achieve one of, a part of or all of the above-mentioned objectives, or to achieve other objectives, an embodiment of the invention provides a projection apparatus, which includes a casing, a light-emitting unit and a reflective component. The casing has an opening. The light-emitting unit is disposed in the casing and emits a first projection beam. The reflective component is disposed in the casing and located on a transmission path of the first projection beam, in which the first projection beam is reflected by the reflective component to become a second projection beam projected out via the opening along a projection direction. The light-emitting unit includes a projection lens, the projection lens has an optical axis, and the optical axis is located between a center of the reflective component and the opening of the casing.

To achieve one of, a part of or all of the above-mentioned objectives, or to achieve other objectives, an embodiment of the invention provides a projection apparatus, which includes a casing, a light-emitting unit and a reflective component. The light-emitting unit is disposed in the casing and emits a first projection beam. The reflective component is disposed in the casing and located on a transmission path of the first projection beam, in which the first projection beam is reflected by the reflective component to become a second projection beam projected out along a projection direction. The light-emitting unit includes a projection lens and the projection lens has an optical axis. The first projection beam is transmitted to the reflective component from the projection lens. The first projection beam has an offset relative to the optical axis on an offset direction, and the offset direction is reverse to the projection direction.

Based on the depiction above, the embodiments of the invention have at least one of the following advantages. In the above-mentioned embodiments of the invention, the offset direction of the first projection beam come from the projection lens is reverse to the projection direction of the second projection beam by design, and the optical axis of the projection lens is located between the center of the reflective component and the opening of the casing, such that the light of the first projection beam deflected from the optical axis may travel along a shorter path to arrive at the reflective component. Thus, the reflective component could have a smaller length along the projection direction, while the casing for accommodating the reflective component has a smaller thickness along the projection direction (for example, smaller than 15 mm) so as to meet the design trend of light and thin figure for the pico projector and the handheld electronic device.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

In order to make the features and advantages of the invention more comprehensible, the invention is further described in detail in the following with reference to the embodiments and the accompanying drawings.

FIG. 1 is a schematic diagram of a known pico projector.

FIG. 2 is a schematic diagram of a projection apparatus according to an embodiment of the invention.

FIG. 3 is a block chart of partial parts of the projection apparatus of FIG. 2.

FIG. 4 is a diagram shown the projection apparatus of FIG. 2 is placed on a desktop.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

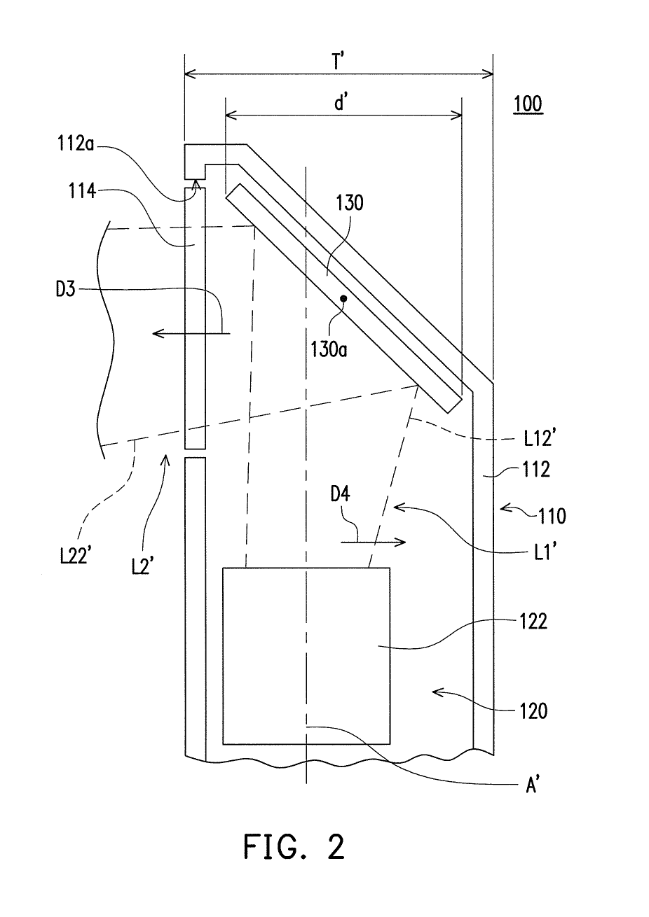

FIG. 2 is a schematic diagram of a projection apparatus according to an embodiment of the invention. Referring to FIG. 2, a projection apparatus 100 of the embodiment is, for example, a pico projector and includes a casing 110, a light-emitting unit 120 and a reflective component 130. The light-emitting unit 120 is disposed in the casing 110 and projects a first projection beam L1′. The casing 110 has an opening 112a. The reflective component 130 is, for example, a reflective mirror and disposed in the casing 110 and located on a transmission path of the first projection beam L1′. The casing 110 is configured to accommodate the reflective component 130. As a result, the thickness T′ of the casing 110 along a projection direction D3 is greater than the length d′ of the reflective component 130 along the projection direction D3.

The first projection beam L1′ is reflected by the reflective component 130 to become a second projection beam L2′ and to be projected out via the opening 112a along the projection direction D3. The light-emitting unit 120 includes a projection lens 122, the projection lens 122 has an optical axis A′ and the first projection beam L1′ is transmitted to the reflective component 130 from the projection lens 122. The first projection beam L1′ has an offset on an offset direction D4 relative to the optical axis A′, and the offset direction D4 is reverse to the projection direction D3 of the second projection beam L2′. In addition, the optical axis A′ of the projection lens 122 is located between the geometric center 130a of the reflective component 130 and the opening 112a of the casing 110.

In the embodiment, the light-emitting unit 120 further includes a light source and a light valve and so on. In order to more clearly understand, the light source and the light valve of the light-emitting unit 120 in FIG. 2 are omitted. In the embodiment, the casing 110 includes a shell 112 and a transparent lid 114. The shell 112 has the above-mentioned opening 112a, and the light-emitting unit 120 and the reflective component 130 are disposed in the shell 112. The transparent lid 114 is, for example, a glass lid and covers the opening 112a of the shell 112 to avoid the outside dust from entering into the shell 112.

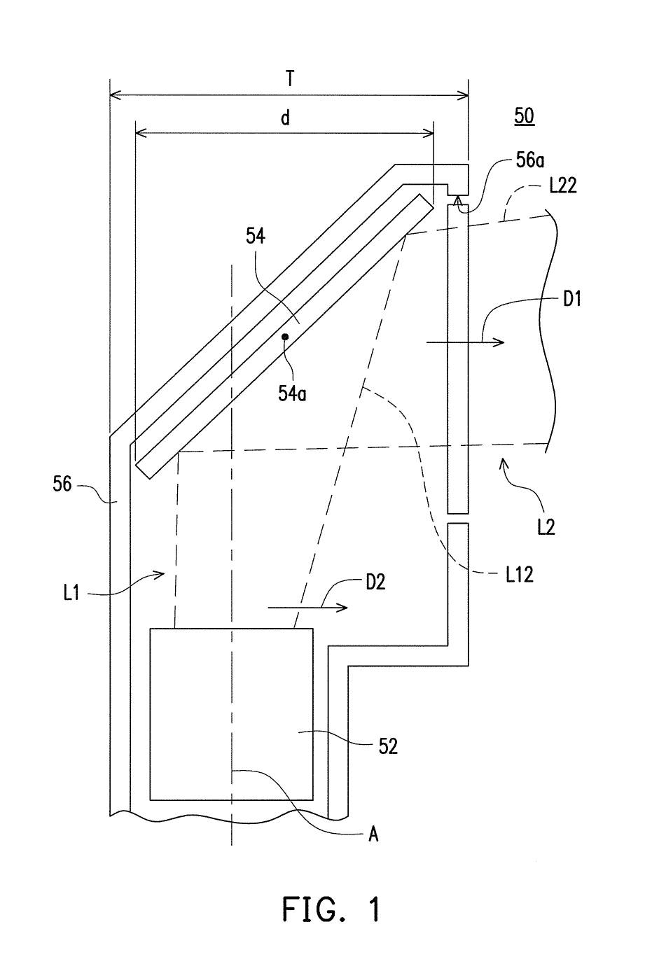

By comparing FIG. 2 with FIG. 1, it is understood that in the projection apparatus 100 of FIG. 2, the reflective component 130 has an inclined direction different from the inclined direction of the known reflective component 54 by disposing shown in FIG. 1 so that the offset direction D4 of the first projection beam L1′ come from the projection lens 122 is reverse to the projection direction D3 of the second projection beam L2′, and the optical axis A′ of the projection lens 122 is located between the geometric center 130a of the reflective component 130 and the opening 112a of the casing 110, such that the light L12′ of the first projection beam L1′ deflected from the optical axis A′ may travel along a shorter path to arrive at the reflective component 130. Accordingly, the reflective component 130 has a smaller length d′ along the projection direction D3 and the transparent lid 114 could be more near to the optical axis A′ of the projection lens 122, while the casing 110 configured to accommodate the reflective component 130 could have a smaller thickness T′ along the projection direction D3. In the embodiment, the thickness T′ of the casing 110 along the projection direction D3 is, for example, less than 15 mm or less than 12 mm to make the projection apparatus 100 meet the design trend of light and thin figure for the handheld electronic device.

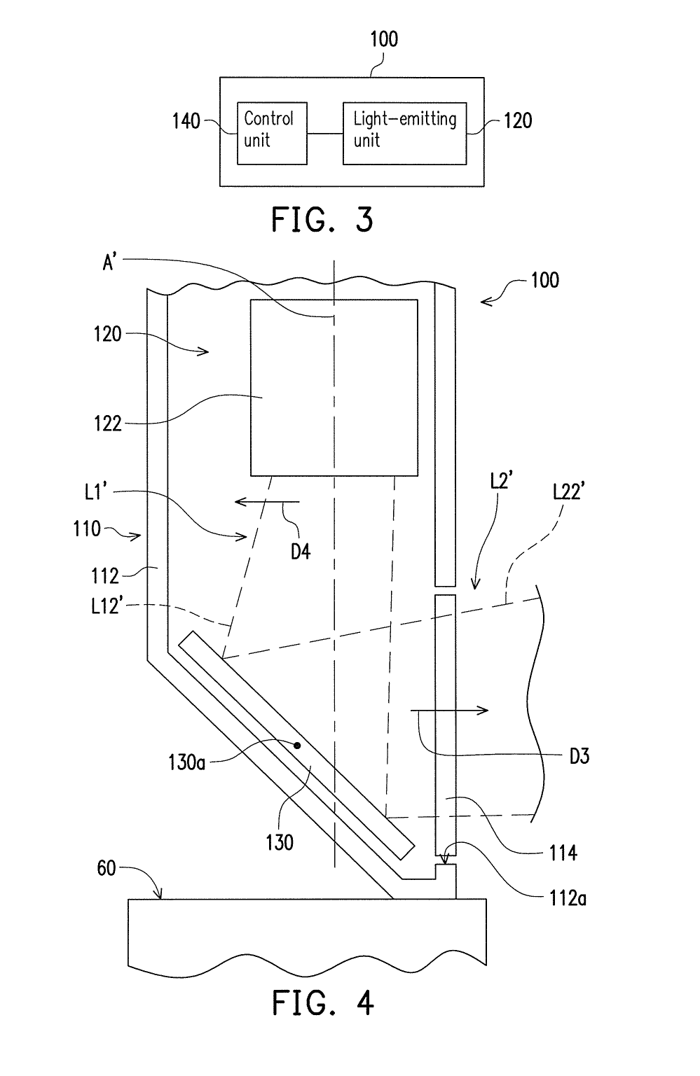

FIG. 3 is a block chart of partial parts of the projection apparatus of FIG. 2. As described above, the reflective component 130 is disposed to have an inclined direction different from the inclined direction of the known reflective component 54 shown by FIG. 1, where the projection frame may be upside down due to the change of the reflection direction of the projection beam. In more details, the light L22 of the second projection beam L2 in FIG. 1 and the light L22′ of the second projection beam L2′ in FIG. 2 are both corresponding to, for example, the upper boundary of the projection frame. Under the layout of FIG. 2, the light L22′ is located at lower portion of the second projection beam L2′ so that the projection frame is upside down. Referring to FIG. 3, the projection apparatus 100 in the embodiment further includes a control unit 140. When the projection frame projected from the projection apparatus 100 is upside down and incorrect, the control unit 140 could use an electronic signal to control the projection frame projected from the projection apparatus 100 to be upside down again to make the projection apparatus 100 project correct projection frames.

FIG. 4 is a diagram shown the projection apparatus of FIG. 2 is placed on a desktop. Referring to FIG. 4, when the user is going to use the projection apparatus 100 for projecting, the projection apparatus 100 of FIG. 2 could be placed on a desktop 60 in upside down orientation as shown in FIG. 4. At the time, the second projection beam L2′ projected from the projection apparatus 100 would be upper-deflected relatively to the desktop 60 so as to avoid the partial second projection beam L2′ from projecting to the desktop 60. In addition, under a condition that the light L22′ (corresponding to the upper boundary of the projection frame) is located at the lower portion of the second projection beam L2′ as shown in FIG. 2 to make the projection frame upside down, the above-mentioned way that the projection apparatus 100 is placed on the desktop 60 in upside down orientation makes the light L22′ (corresponding to the upper boundary of the projection frame) is located at the upper portion of the second projection beam L2′ as shown in FIG. 4, so that the projection frame resumes to be the correct projection frame without being upside down. At the time, no control unit 140 is needed to control the projection frame projected from the projection apparatus 100 to be upside down again.

In summary, the embodiments of the invention have at least one of the following advantages. In the above-mentioned embodiments of the invention, the offset direction of the first projection beam come from the projection lens is reverse to the projection direction of the second projection beam by design, and the optical axis of the projection lens is located between the center of the reflective component and the opening of the casing, such that the light of the first projection beam deflected from the optical axis may travel along a shorter path to arrive at the reflective component. Thus, the reflective component could have a smaller length along the projection direction and the transparent lid is more near to the optical axis of the projection lens, while the casing for accommodating the reflective component has a smaller thickness along the projection direction (for example, smaller than 15 mm or smaller than 12 mm) so as to meet the design trend of light and thin figure for the pico projector and the handheld electronic device.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection apparatus, comprising:
a casing, having an opening;
a light-emitting unit, disposed in the casing and emitting a first projection beam; and
a reflective component, disposed in the casing and located on a transmission path of the first projection beam, wherein the first projection beam is reflected by the reflective component to become a second projection beam projected out via the opening along a projection direction,
wherein the light-emitting unit comprises a projection lens, the projection lens has an optical axis, and the optical axis is located between a center of the reflective component and the opening of the casing.

2. The projection apparatus as claimed in claim 1, wherein the casing comprises:
a shell, having the opening, wherein the light-emitting unit and the reflective component are disposed in the shell; and
a transparent lid, covering the opening.

3. The projection apparatus as claimed in claim 1, wherein the first projection beam is transmitted to the reflective component from the projection lens, the first projection beam has an offset relative to the optical axis on an offset direction, and the offset direction is reverse to the projection direction.

4. The projection apparatus as claimed in claim 1, wherein a thickness of the casing along the projection direction is greater than a length of the reflective component along the projection direction, and the thickness of the casing along the projection direction is smaller than 15 mm.

5. The projection apparatus as claimed in claim 4, wherein the thickness of the casing along the projection direction is smaller than 12 mm.

6. The projection apparatus as claimed in claim 1, further comprising a control unit configured to control a projection frame projected by the projection beam to be upside down.

7. A projection apparatus, comprising:
a casing;
a light-emitting unit, disposed in the casing and emitting a first projection beam; and
a reflective component, disposed in the casing and located on a transmission path of the first projection beam, wherein the first projection beam is reflected by the reflective component to become a second projection beam projected out along a projection direction,
wherein the light-emitting unit comprises a projection lens, the projection lens has an optical axis, the first projection beam is transmitted to the reflective component from the projection lens, the first projection beam has an offset relative to the optical axis on an offset direction, and the offset direction is reverse to the projection direction.

8. The projection apparatus as claimed in claim 7, wherein the casing comprises:
a shell, having an opening, wherein the light-emitting unit and the reflective component are disposed in the shell, and the second projection beam is projected out via the opening; and
a transparent lid, covering the opening.

9. The projection apparatus as claimed in claim 7, wherein a thickness of the casing along the projection direction is greater than a length of the reflective component along the projection direction, and the thickness of the casing along the projection direction is smaller than 15 mm.

10. The projection apparatus as claimed in claim 9, wherein the thickness of the casing along the projection direction is smaller than 12 mm.

11. The projection apparatus as claimed in claim 7, further comprising a control unit configured to control a projection frame projected by the projection beam to be upside down.
